(19) United States
(12) Patent Application Publication
(10) Pub. No.: US 2025/0155743 A1
(43) Pub. Date: May 15, 2025

(54) VARIABLE LIGHT TRANSMISSION GLAZING WITH HIGH COMPLEXITY CURVATURE

(71) Applicant: AGP WORLDWIDE OPERATIONS GMBH, Zug (CH)

(72) Inventors: Natalia Andrea RUEDA GUERRERO, Lima (PE); Andrés Fernando SARMIENTO SANTOS, Canton, MI (US); Yunho SHIN, Canton, MI (US)

(21) Appl. No.: 18/839,398

(22) PCT Filed: Feb. 16, 2023
(86) PCT No.: PCT/IB2023/051427

§ 371 Date: Aug. 16, 2024

Related U.S. Application Data
(60) Provisional application No. 63/310,995, filed on Feb. 16, 2022.

(51) Int. Cl. G02F 1/1333; G02F 1/133; G02F 1/1337; G02F 1/1339

(52) U.S. Cl. CPC G02F 1/133368; G02F 1/13306; G02F 1/133302; G02F 1/133305; G02F 1/133769; G02F 1/133796; G02F 1/1339

(57) ABSTRACT

The disclosure provides means to manufacture liquid crystal based variable light transmission (VLT) glazing with high complexity curvature by utilizing a LC cell comprising a rigid substrate and a flexible substrate.

### FIELD OF THE DISCLOSURE

The disclosure relates to the field of automotive glazing.

### Background of the Disclosure

Many technologies have been developed to dynamically control the level of light transmission through a window. They include electrochromic, photochromic, thermochromic and electric field sensitive films designed to be incorporated into laminated glass. Glazing that incorporate variable light transmittance technologies are sometimes referred to as variable light transmission (VLT), “smart” glass or switchable. While some of the technologies were discovered decades ago, glazing incorporating VLT has not been commercially successful.

While there are a number of glass fabricators who can supply VLT glazing in commercial quantities, VLT glazing still only occupies a small percent of the world glazing market in both the architectural and automotive markets.

The technology has not been in use long enough or on a large enough scale to validate long term durability. Glazing is normally required to last the lifetime of the building or vehicle.

In Aerospace, there has been interest in VLT as it is necessary to have the cabin window shades drawn during some situations

One of the unique features of the composite body, Boeing 787 Dreamliner, is the VLT cabin windows. The glazing was developed by Gentex and PPG Industries and is based upon the Gentex technology used to make automatically dimming, switchable, automotive mirrors. The level of tint, and corresponding level of light transmission of each window, can be controlled by the passenger. Passenger control can be overridden by the flight crew as needed. The windows are made using a gel, containing an electrochromic chemical, sandwiched between two flat sheets of glass. The two flat glass substrates each have a transparent conductive coating, which serves as an electrode, on the face in contact with the gel. A low voltage direct current applied to the conductive coating, induces an oxidation or reduction reaction to take place. In this manner, the tint of the electrochromic chemical containing gel is controlled. The assembled flat electrochromic cell is positioned between the curved interior and exterior glazing.

The electrochromic gel approach is not easily or economically adapted to curved automotive glazing due to issues with maintaining a uniform gap between the electrodes, compliance with regulatory requirements, and in meeting the demanding specifications required for automotive applications.

At best, the ability to form a glass sheet into an automotive glazing shape can be controlled no better than plus or minus 0.5 mm. A non-uniform gap will result in uneven tint the electrochromic material. Each to the two float glass layers has a thickness tolerance of +/−0.05 mm alone which exceeds the allowable variation. In addition, the conductive coating typically used, Indium Tin Oxide (ITO), deposited as an electrode on a glass substrate, cannot be heated and bent to shape without damaging the coating and breaking the electrical continuity of the coating.

Typical automotive specifications require parts to not only meet the functional requirements for the life of the vehicle but also to be able to survive extremes of temperature, 100% humidity, extended exposure to intense UV, as well as exposure to water and salt without degradation. To meet regulatory requirements, the visibility through the glazing and optical quality also must not deteriorate for the life of the glazing. Protecting the material comprising the VLT glazing from long term UV damage, especially the organic compounds, can be challenging.

In certain glazed positions, the glazing must also meet requirements for occupant retention in the event of a wreck and when impacted from the exterior, resistance to penetration and spalling. These requirements can be difficult to meet even with ordinary glazing. This is difficult if not impossible with the electrochromic gel technology.

One approach, that has been found capable of meeting both automotive and architectural requirements, uses a solid electrochromic active variable light transmission material rather than a gel. A number of compounds are known that can change from transparent to dark and back, when undergoing an oxidation or reduction reaction in response to a low voltage direct current. The material, deposited upon a glass substrate, is sandwiched between a set of transparent, conductive coating, electrodes. This eliminates the issue of gap variation as only one of the glass layers needs to have the active material applied. This type of VLT glazing has been produced for architectural and automotive applications as demonstrated in WO2005076061A1. The primary technical drawback is that even with the thickness of the active material kept very uniform, the rate of change is dependent upon the electrical current which is difficult to control across the entire surface. States between full dark and full light tend to be non-uniform. As a chemical reaction takes place, the time that it takes to change states is measured in minutes. As the electrodes are only separated by the thickness of the active material measure in microns, the coating deposition must be carefully controlled to prevent shorting and arcing. Applying a layer of active material with uniform thickness and the conductive coating requires a large capital investment in expensive equipment, with a large footprint, not normally used to fabricate automotive glazing, as well as a high level of expertise, and licensing of the relevant technology.

One approach disclosed in EP1227362B1 is based on electrodeposited tungsten oxide, Prussian Blue and a Lithium ion conducting PVB interlayer. A first active material is applied over a transparent conductive coating on one glass surface but rather than having the material sandwiched between a set of transparent conductive coatings on the same substrate, a transparent conductive coating and a second electrochromic material is applied to the adjacent and opposite face of the second glass layer. The glass is then laminated using a Lithium-ion conductive plastic interlayer. When a voltage is applied to the conductive coating of each surface the flow of current through the plastic interlayer results in a very uniform change in light transmission through the entire range without the risk of short circuits and arcing. This process has a major drawback in the electrodeposition process which requires an extended period of time. To increase throughput to a commercially viable level required a major investment in many electrodeposition cells.

A number of VLT technologies have been developed that are based upon the kinetic response of a particle or molecule to an electrical field. These include, Suspended Particle Devices (SPD), Polymer Dispersed Liquid Crystal (PDLC), and Liquid Crystal (LC).

All of the VLT technologies in the dark state, remain transparent and continue to allow some light to be transmitted regardless of their activation state. The dark state is considered at the state in which light transmission is the lowest. Likewise, clear is the state in which light transmission is the highest.

SPD is a type of VLT in which the level of tint can be controlled and varied in response to an applied electrical field. SPD goes from dark in the unpowered state to clear in the powered state. In an SPD film, microscopic droplets of liquid containing needle like opaque particles, known as light valves, are suspended in a polymer matrix. In the off state the particles are in a random state of alignment and block the transmission of light. The degree of alignment and resulting tint can be varied in response to the applied voltage. The level of light transmittance in the on and off states can also be shifted through changes to the thickness and composition of the active material. In the off state, it is still possible to see clearly through SPD. The primary drawback of SPD is its strong blue tint. Haze, the high operating voltage, and the limited range of light transmission are also issues.

PDLC is a light scattering technology which goes from light scattering with high haze in the dark off state to clear in the on state. In a PDLC film, microscopic droplets of liquid crystal are suspended in a polymer matrix. In the off state the liquid crystals are in a random state of alignment scattering the light and providing privacy. When an electric field is applied, the crystals align and allow light to pass. The degree of scattering can be controlled by varying the amplitude of the applied voltage. The level of light transmittance in the on and off states can also be shifted by making changes to the thickness and composition of the active material. PDLC is primarily a privacy product though it can also be used for solar control as it reduces the solar energy transmitted through the glazing. The primary drawback of PDLC is the whitish color that it takes on in the off state. Like SPD, haze, the operating voltage, and range of light transmission are also issues.

Upon the loss of power, SPD and PLDC both fail in the dark state. For safety reasons, SPD and PDLC cannot be used in applications where an abrupt loss of or reduction in visibility would be dangerous as is the case when power is lost. Both also require a relatively high alternating current voltage in the 50-100 Volt range. The higher voltage increases the risk of shock and requires additional circuit protection and insulation.

LC is similar to PDLC. The active material in LC is also liquid crystal. However, rather than encapsulating the liquid crystal in a polymer matrix, the two conductive coated substrates are separated by spacers, the edge is sealed and then the gap is filled with liquid crystal.

Electrochromic switchable glazing undergoes a chemical reaction when a current is passed through the active material, in much the same way that a battery functions when it charges and discharges. The active material undergoes an oxidation or reduction reaction as the materials changes from light to dark and back. The time that this takes is measured in minutes.

SPD, LC and PDLC however operate on a different principle in comparison with electrochromic. There is no chemical reaction. The molecules that make up the active material undergo a kinetic change in response to the presence of an electrical field.

Therefore, the switching time of SPD and PDLC is orders of magnitude faster than electrochromic glazing, measured in seconds or fractions of a second.

LC cell glazing has typically been implemented using rigid sheets of conductive coated glass for both substrates. An alignment layer is applied over the coated surfaces. Spacers are applied to maintain a constant gap between the substrates. The substrate edges are sealed and the gap between the two substrates is then filled with a liquid crystal emulsion.

The transparent conductive coating is selected from the group comprising: metallic/dielectric, ITO, ITO over a metallic/dielectric, carbon nanotubes, silver nanowires, ITO plus carbon nanotubes, ITO plus silver nanowires, or polymeric conductive coating. A typical transparent conductive coating used is an ITO based coating.

The alignment layer is a physical mechanism which is comprised of a layer of polyimide or other material with similar properties, which is deposited on top of the conductive layer of both, first and second substrate. The alignment layer is mechanically rubbed to imprint a pattern that forces molecules to align in a specific direction.

Alternately, photoalignment may be used to replace the alignment layer. There is also the option of using chemical alignment, where reactive mesogen molecules are introduced to the LC emulsion.

The spacer structure maintains a cell gap between the two substrates. A number of methods are in use which include but are not limited to: ball sprayed spacers, photolithographic printed spacers, printed spacers, column spacers, and a combination of the above mentioned.

As the active material is a liquid, the edge of the cell must be sealed. An edge seal is dispensed and cured around the perimeter of the LC cell.

If the LC cell is encapsulated inside of a laminated glazing, then a second edge seal may be required to protect the LC cell. This second edge seal may be of a different material and is placed between the two glass layers of the laminate. If the glazing is laminated by means of a liquid optically clear adhesive (LOCA) and edge seal is required. We note that the PVB and other commonly used solid interlayers are essentially optically clear adhesives as well.

A connection system that has at least one connection to the first conductive layer and at least one connection to the second conductive layer, is used to connect the LC cell with the power unit. The connection system can be comprised of a number of means including but not limited to a flexible printed circuit (FPC), a conductive tape, a conductive adhesive, a conductive silver frit printed on the glass, or a conductive coating.

LC originally had a high level of haze in the powered clear state and also had the same milky with color in the unpowered state as PDLC. Also, like SPD and PDLC, LC failure mode resulted in a transition to the dark state.

In recent years, substantial improvements have been made in LC technology. Versions are available that have a failure mode, i.e., loss of power, in either the clear state or in the dark state, i.e., turning to either the clear or dark state when its power fails.

LC that is dark in the off state, without power, is known as normal dark or normal black. One example is an LC that has haze that at least 20% and light transmission of less than 2% in the dark, unpowered, off state and in the clear, powered, on state, has a haze level of less than 3% with visible light transmission ranging from 20 to 40%.

LC that is clear in the off state, without power, is known as normal clear or normal white. An example includes one that has a haze level equal or less than 2% and light transmission in the range of 25%-60%, in the clear, unpowered clear state, depending on the type of liquid crystal used. In the on state (dark state) it has haze of less than 10% and transmission less than 30%.

LC operates at a range from 5 volts rms for twisted nematic based mixtures, emulsions, and 20-25 volts rms for Guest Host with chiral dopant and dichroic dye mixtures. This places LC in the low-voltage class which lowers the cost of the supporting electronics and wiring.

While both haze and transmission are sensitive to the viewing angle, LC is less sensitive than PDLC.

The biggest advantage of LC perhaps is color. LC in the dark state takes on shades of gray/black which is preferred to the deep blue of SPD and the milky white of PDLC.

These improvements have the potential to overcome market resistance as well as to reduce the cost of production making it highly desirable in the automotive market.

LC can be implemented as an LC cell comprised of thin flexible films that are laminated within a glazing. The LC cell is comprised of a layer of the liquid crystal emulsion sandwiched between two thin flexible plastic layers having a transparent conductive coating on one side of each thin flexible plastic film and being in contact with the liquid crystal. The conductive coating on the plastic substrates serves as the electrodes. An alignment layer is deposited over each of the conductive coated surfaces. The real resistance between the electrodes is in the mega-ohm range so very little real power is consumed. The film impedance is capacitive. Bus bars are applied to each to the conductive coated surfaces and then the cell is laminated in between two plastic bonding layers to form a laminated glazing. Spacers are required to maintain a uniform gap within the LC cell.

A major limitation of LC cells is encountered when we attempt to implement an LC cell in a glazing with high complexity curvature. It should be noted that high complexity curvature should be understood as any glazing that requires a substantial amount of plastic deformation, wherein the surface area of the substrate changes by a value greater than 1-3%, to take place when bending the flat glass to the final design shape. Examples include glazing with a radius of curvature of less than 4 meter in one direction or curvature in at least two directions such that the radius is less than 6 meters in at least one of the two directions. The actual maximum value will depend upon the Elastic modulus (Young's Modulus) of the material, the thickness, and the actual glazing geometry.

The flexible thin film used as a substrate for the conductive coating is typically Polyethylene Terephthalate, PET. During the lamination process, the PET based film is placed between the plastic bonding layers and the glazing glass layers in a clean room, typically chilled to prevent sticking of the interlayers. The assembled laminate is then placed in an airtight bag, or a ring with channel is applied along the edge of the assembled layers. Vacuum is then drawn. Under the pressure created by the vacuum, the PET will stretch and undergo some elastic deformation. However, there is a limit to this deformation and defects such as wrinkles, delamination of the PET layers, shorting of the conductive coating and breaks in the brittle coating can occur. In addition, the gap between the two substrates must be maintained, otherwise, the liquid crystal layer may become too thick or too thin resulting in areas that do not respond to the electric field correctly.

It would be highly desirable to have a method capable of forming VLT films to high complexity curvatures while maintaining optical and electrical properties.

### BRIEF SUMMARY OF THE DISCLOSURE

The disclosure refers to a variable light transmission cell, comprising: a set of at least two electrical connectors wherein said connectors serve to conduct electrical current between said cell and an electrical current source; a rigid substrate with high complexity curvature coated with a transparent conductive coating, wherein said conductive coating is in electrical contact with the first electrical connector; a flexible substrate coated with a transparent conductive coating, wherein said conductive coating is in electrical contact with the second electrical connector; at least one alignment layer deposited over the transparent conductive coating of either or each one-off said rigid and flexible substrates; spacers in between the rigid and the flexible substrates to maintain a uniform gap between the substrates; an edge seal wherein said edge seal serves to bond and seal the rigid and the flexible substrates positioned such that the transparent conductive coating of each one of said substrates are facing each; and an electrically controlled variable light transmission material filling the gap between the rigid and the flexible substrates.

In addition, it refers to A method of manufacture of variable light transmission cell, comprising the steps of: providing a rigid substrate; applying a transparent conductive coating to said rigid substrate; applying a first electrical connector to said rigid substrate wherein said first electrical connector is in electrical contact with said transparent conductive coating; applying an alignment layer to said rigid substrate over said coating; forming said rigid substrate to the desired shape such as to form a high complexity curvature; providing a flexible substrate; applying a transparent conductive coating to said flexible substrate; applying a second electrical connector to said flexible substrate wherein said second electrical connector is in electrical contact with said flexible transparent conductive coating; applying spacers to said rigid substrate or applying spacers to said flexible substrate or applying spacers to the gap between the two substrates such that the gap formed is uniform; bringing the two substrates together with the transparent conductive coating on the flexible and rigid substrates facing each other such that the flexible substrate is formed to the rigid substrate taking the same high complexity curvature and forming an assembly; sealing and bonding the edges of the assembly with an edge seal; and filling the gap of said sealed assembly with a variable light transmission matrix.

In a specific embodiment, the liquid crystal glazing of the disclosure is comprised of a glass laminate encapsulating a formed liquid crystal cell. The LC cell comprises a set of substrates, one rigid and one flexible. Each substrate is coated with a conductive transparent coating as well as an alignment layer. An electrical connection is applied to each of the transparent conductive coated substrates. The substrates are formed and then joined together, with the coated side of each substrate facing the interior of the cell, and the edge is sealed with an edge seal. The cell is then filled with liquid crystal. The gap between the substrates is maintained at a uniform distance by means of spacers.

The assembled cell is laminated between a set of at least two curved glass layers and two plastic bonding layers. The plastic bonding layers may be comprised of a solid or liquid plastic. The rigid glass substrate of the LC cell may comprise one of the two glass layers or the laminate.

The substrates of the LC cell may be formed to a high complexity curvature. Any one of or any combination of the conductive coating, alignment layer and spacers may be applied to one or both substrates prior to forming or after forming. A flexible transparent coating may be used in place of the typical ITO if applied prior to forming. Flexible transparent coatings include but are not limited to metallic/dielectric, carbon nano tubes, silver nano wires, ITO with carbon nanotubes and ITO with silver nano wires. The cell may be filled with liquid crystal before or after lamination.

### BRIEF DESCRIPTION OF THE DRAWINGS

FIG. 1A is a cross section of a typical laminated automotive glazing.

FIG. 1B is a cross section of a typical laminated automotive glazing with performance film and performance coating.

FIG. 1C is a cross section of a typical tempered monolithic automotive glazing.

FIG. 2 is a top view of laminated LC roof with high complexity curvature.

FIG. 3 is an isometric exploded view of laminated variable light transmission roof with high complexity curvature.

FIG. 4 is an exploded view of LC cell.

FIG. 5 is a cross section of a typical LC cell.

FIG. 6 is a cross section of a laminated LC cell with the inner glass layer of the laminate serving as the rigid cell substrate FIG. 7A is a cross section of a PVB laminated LC cell with an IR reflecting coating applied to surface two.

FIG. 7B is a cross section of a PVB laminated LC cell with an IR reflecting coating applied to surface two and with the rigid layer of the LC cell serving as the inner glass layer of the laminate.

FIG. 8A is a cross section of a LOCA laminated LC cell with an IR reflecting performance film between the outer glass layer and the LC cell.

FIG. 8B is a cross section of a LOCA laminated LC cell with an IR reflecting coating applied to surface two and with the rigid layer of the LC cell serving as the inner glass layer of the laminate.

FIG. 9A is a cross section of a PVB laminated LC cell with an IR reflecting coating applied to surface two of the outer glass layer and with a special UV blocking PVB between the outer glass layer and the LC cell.

FIG. 9B is a cross section of a PVB laminated LC cell with an IR reflecting coating applied to surface two of the outer glass layer and with a special UV blocking PVB between the outer glass layer and the LC cell and with the rigid layer of the LC cell serving as the inner glass layer of the laminate.

FIG. 10A is a cross section of a LOCA laminated LC cell with an IR reflecting coating applied to surface two.

FIG. 10B is a cross section of a LOCA laminated LC cell with an IR reflecting coating applied to surface two and with the rigid layer of the LC cell serving as the inner glass layer of the laminate.

FIG. 11A is a cross section of a PVB laminated LC cell with both an IR reflecting performance film and a specially formulated UB block PVB.

FIG. 11B is a cross section of a PVB laminated LC cell with both an IR reflecting performance film and a specially formulated UV block PVB with the rigid layer of the LC cell serving as the inner glass layer of the laminate.

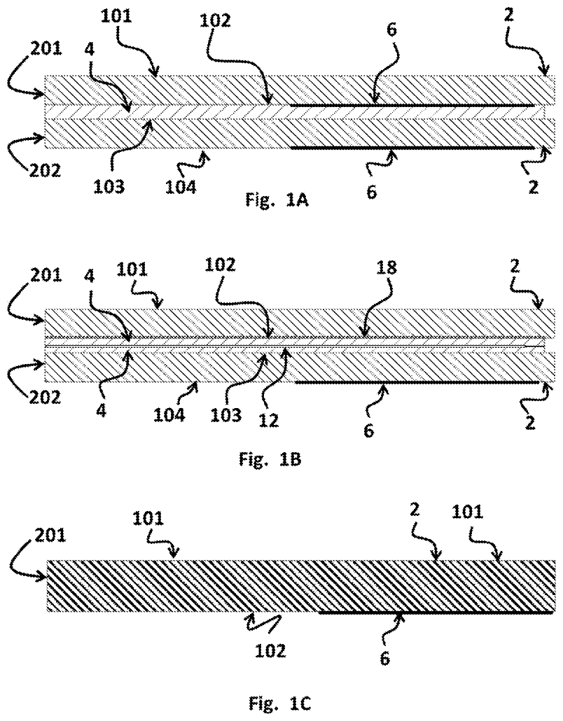

### REFERENCE NUMERALS OF DRAWINGS

2 Glass
4 Bonding/Adhesive layer (plastic Interlayer)
6 Obscuration/Black Paint
12 Infrared reflecting film
18 Infrared reflecting coating
20 Rigid substrate
22 Flexible substrate
24 Transparent conductive coating
26 Alignment layer
28 Edge seal
30 Liquid crystal
32 Spacer
34 Liquid crystal cell
40 Bus bar
42 Liquid Optically Clear Adhesive (LOCA)
44 Edge of glass seal
100 Laminated roof
101 Exterior facing side of glass layer 1 (201), number one surface
102 Interior facing side of glass layer 1 (201), number two surface
103 Exterior facing side of glass layer 2 (202), number 3 surface
104 Interior facing side of glass layer 2 (202), number 4 surface
201 Outer glass layer
202 Inner glass layer

### DETAILED DESCRIPTION OF THE DISCLOSURE

The present disclosure can be understood more readily by reference to the detailed descriptions, drawings, examples, and claims of this disclosure. However, it is to be understood that this disclosure is not limited to the specific compositions, articles, devices, and methods disclosed unless otherwise specified. It is also to be understood that the terminology used herein is for the purpose of describing aspects only and is not intended to be limiting.

In addition, while the focus of the embodiments and the discussion is on automotive applications of the disclosures, the disclosure has equal utility in many other types of applications including but not limited to aerospace, architectural, marine, transit vehicle and commercial vehicles and is not limited to automotive glazing.

Specific materials disclosed may be substituted by other materials that are obvious functional equivalents without departing from the claims of the disclosure. As an example, ITO may be doped with various other elements resulting in other equivalent transparent conductive coatings.

The following terminology is used to describe the glazing of the disclosure.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

The term “glass” can be applied to many inorganic materials, include many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Laminates, in general, are articles comprised of multiple layers of thin, relative to their length and width, material, with each thin layer having two oppositely disposed major faces, typically of relatively uniform thickness, which are permanently bonded to one and other across at least one major face of each layer. The layers of a laminate may alternately be described as sheets or plies. In addition, the glass layers may also be referred to as panes.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer also helps to prevent penetration by objects striking the laminate from the exterior and in the event of a crash occupant retention is improved.

Safety glass is glass that conforms to all applicable industry and government regulatory safety requirements for the application. Laminated safety glass is made by bonding two layers of annealed glass together using a plastic bonding layer comprised of a thin sheet of transparent thermo plastic.

The plastic bonding layer (interlayer) has the primary function of bonding the major faces of adjacent layers to each other. The material selected is typically a clear thermoset plastic. For automotive use, the most used bonding layer 4 (interlayer) is polyvinyl butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over a wide range over the temperature range required for an automobile. Only a small number of plasticizers are used. They are typically linear dicarboxylic esters. Two in common use are di-n-hexyl adipate and tetra-ethylene glycol di-n-heptanoate. A typical automotive PVB interlayer is comprised of 30-40% plasticizer by weight. Automotive grade PVB has an index of refraction that is matched to soda-lime glass to minimize secondary images caused by reflections at the PVB/Glass interface inside of the laminate.

In addition to polyvinyl butyl, ionoplast polymers, ethylene vinyl acetate (EVA), cast in place (CIP) liquid resin and thermoplastic polyurethane (TPU) can also be used. A liquid optically clear adhesive (LOCA) is an adhesive that is designed for and typically used to bond optical components. A LOCA may also be used to bond the layers of a laminate.

The structure of the disclosure is described in terms of the layers comprising the glazing. The meaning of “layer”, as used in this context, shall include the common definition of the word: a sheet, quantity, or thickness, of material, typically of some homogeneous substance and one of several.

A layer may further be comprised of non-homogeneous and also of multiple layers as in the case of a multi-layer coatings such as solar coatings. When multiple layers together provide a common function, the multiple layers may be referred to as a layer even if the multiple layers comprising the layer are not adjacent to each other. An example would be a solar protection layer comprising: a solar absorbing glass inner glass layer and a solar reflecting coating applied to the outer glass layer.

A typical laminated windshield comprises two glass layers and a plastic interlayer. An interlayer layer is generally of the same area as the glass layers. The typical laminate may further comprise additional layers including but not limited to coatings and films. The surface area of a layer may be substantially less than that of the glazing. A film layer will have a smaller area than the glass. An obscuration layer will have an area that is substantially less than that of the glass.

Other types of material and components may also be included within the structure. A lighting or heating circuit may be referenced respectively as the lighting layer or the heating layer even though the layer comprises multiple separate components rather than a substantially flat homogeneous sheet of material. In this case, the reference is to the position within the thickness in much the same way that we would reference the floor of a building.

When multiple layers that vary widely in thickness are illustrated, it is not always possible to show the layer thicknesses to scale without losing clarity. Unless otherwise stated in the description, all figures are to be considered as for illustrative purposes and are not drawn to scale and thus shall not be construed as a limitation.

Haze is a measure of how much light is scattered by a transparent material. Automotive laminates will typically have a haze of less than 2% and preferably as low as possible. Some performance films, interlayers and coatings will increase the haze.

While the focus of the discussion and embodiments of this disclosure is on liquid crystal cells, this not to be construed as a limitation. Various other materials may be used to fill the void between the rigid and flexible substrates of the disclosure. The variable light transmission cell of the disclosure may be practiced with any electrically controlled variable light transmission material. These materials include but are not limited to: polymer dispersed liquid crystal, SPD emulsion, electrochromic or electrophoretic materials.

The electrical connection supplying power to the glazing can be provided by a number of means including but not limited to and one or any combination of: thin solid metal strip, stranded wire, solid wire, braided wire, flexible printed circuit, conductive inks, silver frit, and conductive tape.

The LC cell of the disclosure comprises a set of two substrates, a rigid substrate, and a flexible substrate. Both terms can be difficult to quantify as they are relative and dependent upon a number of factors including the actual geometry and the material used. Axial stiffness is defined at the Young's Modulus of the material multiplied by the cross-sectional area over the length. For two substrates of the same material and overall dimensions, with one being twice as thick as the other, the axial stiffness of the thicker will be double that of the thinner regardless of the length used as it will always be the same for both substrates. The area of both is also the same so we only need the thickness in the cross-sectional area term. So, the relative stiffness is the ratio of the Young's Modulus times the thickness. The stiffness of the rigid substrate should be sufficient that the substrate does not deform under its own weight and during normal handling. The rigid substrate should have an axial stiffness at least 50% greater than that of the flexible substrate, preferably 100% great and preferably 200% greater.

For very thin conductive materials we typically characterize the resistance in terms of the sheet resistance. The sheet resistance is the resistance that a rectangle, with perfect bus bar on two opposite sides, would have. Sheet resistance is specified in ohms per square.

This is a dimensionally unitless quantity as it is not dependent upon the size of the rectangle. The bus bar to bus bar resistance remains the same regardless of the size of the rectangle.

The coating utilized by the disclosure does not require an extremely low sheet resistance as very little real power is drawn by an LC cell. Values of sheet resistance in the range of 100-200 ohms per square are typical although substantially higher values of sheet resistance may still function depending upon a number of other factors including but not limited to the liquid crystal layer thickness, the type of liquid crystal, the area of the variable light transmission region and the placement of the bus bars.

ITO has been the transparent conductive coating of choice and dominates in the field of flat displays and touch screens. In addition to ITO, several other transparent conductive coatings are known. A variety of means may be used to deposit them including Magnetron Sputtered Vacuum Deposition (MSVD), spray, controlled vapor deposition (CVD), dip, sol-gel, and others. For LC cell applications the coating is typically applied to the substrates by means of vacuum sputtering of the ITO.

ITO coatings, however, are brittle, much like glass. When vacuum sputtered, they start as amorphous but start to take on the more brittle crystalline form after only 40 μm. As a result, when forming an ITO coated flat substrate, weather it is glass or plastic, the primary problem encountered is the durability of the conductive coating.

High complexity curvature has been defined in the previous section. Basically, any glazing that requires a level of deformation in excess of 1-3% to form is considered as having a high complexity curvature. This can include parts with curvature in just one direction but also applies to glazing with curvature in more than one direction. Further, the curvature need not be and frequently is not constant. It is rare to find a true spherical, cylindrical, or toroidal shape. In an automobile, the glazing is usually designed to match the sheet metal as the edge of glass, maintaining geometric continuity and then continuing and changing as the surface blends into the other surfaces. Flat surfaces are generally avoided as minor irregularities in the bend will show up and it is difficult to heat and bend glass while maintaining flat areas.

For shapes requiring a level of deformation to form in excess of the range of 1-3%, the ITO coating is not likely to survive. When subject to a high enough level of stress, like other brittle materials, the ITO coating will crack, buckle and spall. When this happens, electrical continuity can be lost, and the film will no longer function as intended.

There are a number of alternate transparent conductive coatings that can be used that are not as brittle and easily damaged. Coatings that utilize a soft ductile metal are known.

Normally, depositing a metallic coating onto a glass substrate will result in a mirror. However, by also depositing various other layers, including at least one dielectric layer, the metallic layer can be rendered transparent in the visible light range. This is the principle that solar control coatings are based upon.

The phrase “silver/dielectric” shall include the various complex coating stacks which utilize at least one functional metallic silver or silver alloy, or doped silver layer deposited adjacent to at least one dielectric layer.

Solar control coatings generally have a sheet resistance of less than 10 ohms and so make excellent electrodes. Any solar coating, which does not react with the liquid crystal can be used. While these coating can also crack, they can withstand and remain intact at much higher levels of deformation. The more amorphous the layers the less likely the coating is to crack during glass bending. Methods are known and disclosed in the U.S. Patent Application 63/294,954 by Krasnov et al. to produce transparent conductive solar coatings with highly amorphous layers prior to bending.

Other conductive coatings that are easily applied and which also have excellent conductivity and formability characteristics are known. These include carbon nanotubes and nano-silver wires. Both are monolithic in structure and have been used commercially to produce heated circuits for glazing.

The conventional ITO conductive coatings can be enhanced by the addition of nano-silver wires or carbon nanotubes. While the ITO is just as brittle and will crack, continuity will be maintained by the added conductors.

Preferably, the nanowires or carbon nanotubes are added while the ITO is still in an amorphous state of deposition. The ITO will start to crystalize at a layer thickness of approximately 40 μm or above. This allows the film to be stretched and formed without loss of electrical continuity as the nano conductors will tend to move and bridge any gaps formed.

Another option to provide a durable transparent conductive coating is to first deposit a thin, largely amorphous, metallic/dielectric stack and then apply the ITO or other monolithic coating over. This allows for the use of metallic/dielectric coating that otherwise would not be compatible with the active material.

It is preferred to apply the coating prior to forming as the typical and most economical means makes use of the MSVD process which is not well adapted to curved shapes. However, there are a number of less desirable but feasible methods that can be used to apply the transparent conductive coating after the substrate has been formed. This includes but is not limited to vacuum sputtering and sol-gel.

Likewise, the spacers can be applied before or after forming of the substrates. The micron dimensioned spacers are spaced in the gap between the substrates and sized to maintain a uniform distance between the two opposite conductive coated surfaces of the thin flexible plastic substrate.

In the same manner, the alignment layer may be applied over the conductive coating before or after forming of the substrate.

Each substrate is formed by methods appropriate and typical of the material comprising each substrate.

While PET is the typical plastic used for as the thin flexible substrate, there are several other equivalent thermoplastics that may be used selected from the group of: polymethyl methacrylate (PMMA), polycarbonate (PC), polyethylene terephthalate (PET), polyethylene terephthalate glycol (PETG), pentaerythritol tetraacrylate (PETA), polyethylene naphthalate (PEN), polyimide (PI), cellulose triacetate (TAC), cyclic olefin polymer (COP), low-density polyethylene (LDPE), linear low-density polyethylene (LLDPE), high-density polyethylene (HDPE), and polypropylene (PP). While the discussion and embodiments center around PET, PET is in no way to be considered as a limitation. The flexible substrate could also be a thin transparent glass selected from the group of soda lime, aluminosilicate, borosilicate, or any other transparent glass. The rigid substrate may be selected of the same group of thermoplastic or glass materials as of the flexible substrate. In one embodiment the Elastic Modulus of the rigid substrate is different than the Elastic Modulus of the flexible substrate, and consequently the composition of one substrate is different from the other. In another embodiment, the rigid and the flexible substrate are made of the same material composition. In this situation the axial stiffness of the rigid material should be greater than the flexible material. In another embodiment, the thickness of the rigid substrate should be larger than the thickness of the flexible material.

If the level of deformation is too high, going directly from the flat film to the final high complexity curvature may not be recommended. Instead, the final shape may be approached in steps with each substrate is partially formed at each point and with the complexity increasing each time until the final high complexity curvature is reached. This concept has been demonstrated for glazing in the U. S. Patent Application 63/062,938.

As an example, if there is a shape that requires a deformation of 5% but the substrate material is only capable of 2%, it can first be formed the substrate to the shape requiring 2% and then repeat for another 2% and then for a third and final time to get to the total of 5%. It may be possible to form the substrates only partially to the final shape. In this example, we take the substrates bent to the 4% level and laminate with fully formed glass layers. During the lamination process the heat and pressure results in the final 1% deformation needed.

The steps may require separate molds or forming may be done incrementally on the same mold dependent upon the shape.

In general, the deformation will be calculated by Finite Element Analysis (FEA) means and the feasibility analyzed to determine if multiple forming steps are needed or not and if required how far the film may be deformed at each step.

In one embodiment, the rigid substrate is first formed and then used as a mold to form the flexible substrate. A single rigid substrate may be used to form several flexible substrates, or they may be bent in pairs. This allows the flexible substrate to form to the exact contour of the rigid substrate and undergo plastic deformation. Otherwise, any surface mismatch is corrected during lamination as the two substrates are compressed by the laminate. This method requires that the glass transition range of the flexible substrate to be lower than that of the rigid substrate.

As discussed, regardless of the type of substrate used to form an LC cell, all have similar cross sections. All utilize two substrates with a transparent conductive coating on one side of each substrate. The coating serves an electrode to distribute the electrical field needed to change the alignment of the liquid crystal molecules. An alignment layer is then required to be deposited over the electrode. An electrical connection means is also needed to bring the electrical current from the outside of the cell to the electrodes.

In order to produce an LC cell with a high complexity curvature a flexible and a rigid substrate are used rather than two rigid or two flexible substrates. Both substrates are formed to the desired shape. During the lamination, the flexible substrate is forced to take on the contour of the rigid substrate compensating and correcting for any difference between the flexible and rigid substrates. This overcomes the issue of providing a uniform thickness gap between the substrates.

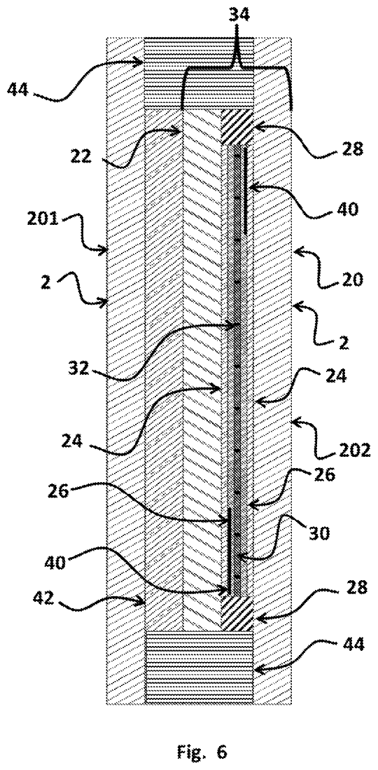

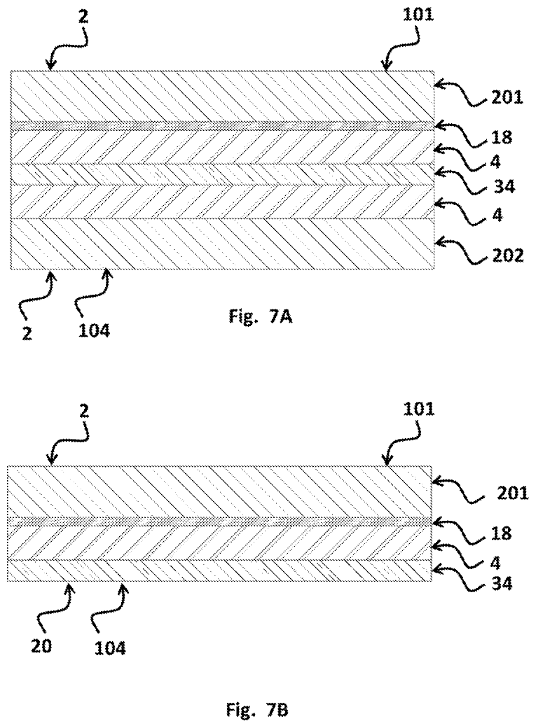

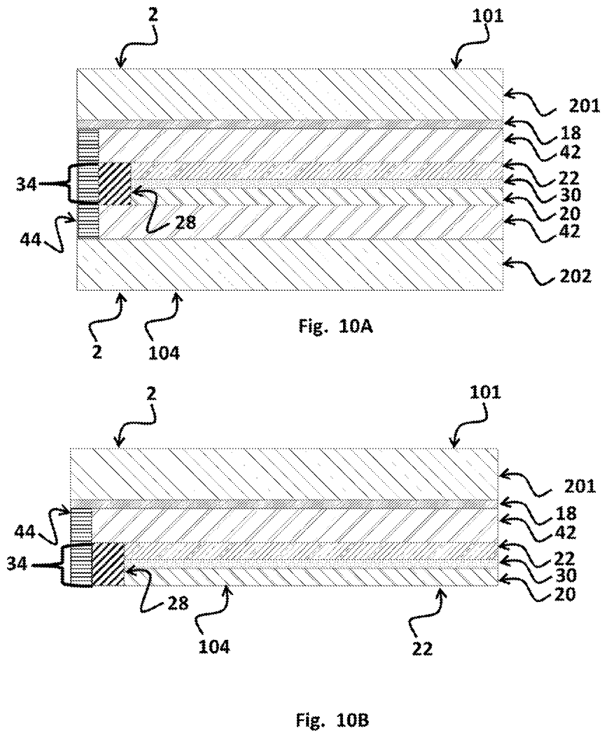

As a laminated glazing normally is comprised of at least two rigid layers and the LC cell of the disclosure has one rigid substrate 20, the rigid substrate 20 of the LC cell 34 may serve as one of the rigid layers of the laminate. Cross sections illustrating this concept are shown in FIGS. 6, 7B, 8B, 9B, 10B and 11B. The same cross section with the LC cell laminated within a typical laminate are shown in FIGS. 7A, 8A, 9A, 10A and 11A.

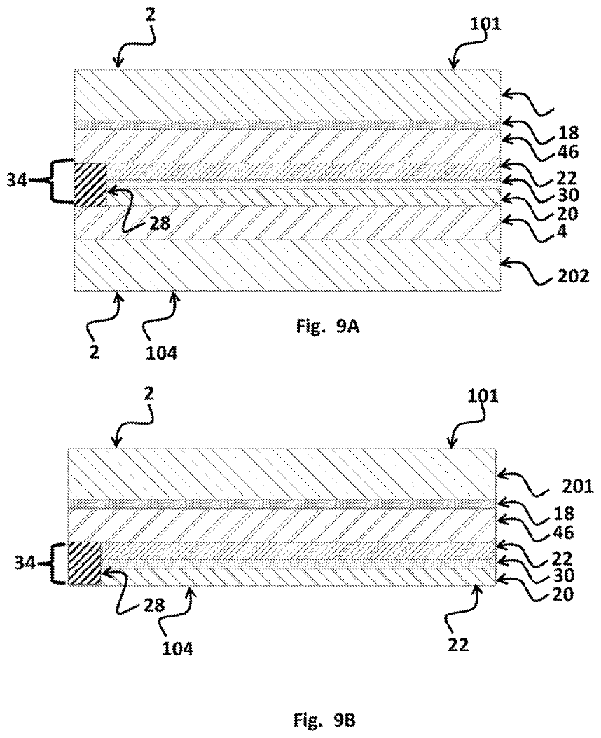

The variable light transmission emulsion material such as liquid crystal fill and the various organic substrates and materials are subject to UV degradation and must be protected. The typical automotive PVB interlayer 4 is formulated with UV blockers that stop 99% of UV radiation. Thus, standard automotive PVB serves as a UV blocking layer. However, this may not be sufficient for some materials. For these more susceptible materials a specially formulated UV block layer 46 interlayer must be used which blocks UV-A, UV-B and visible in the near UV, particularly in the range of 280 to 400 nm. Cross sections with a special enhanced UV block layer 46 are illustrated in FIGS. 9A, 9B, 10A, 10B, 11A and 11B.

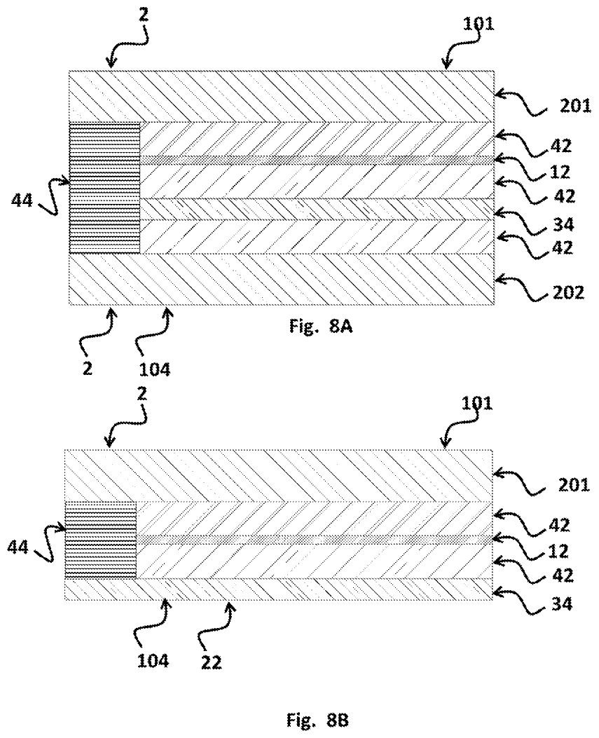

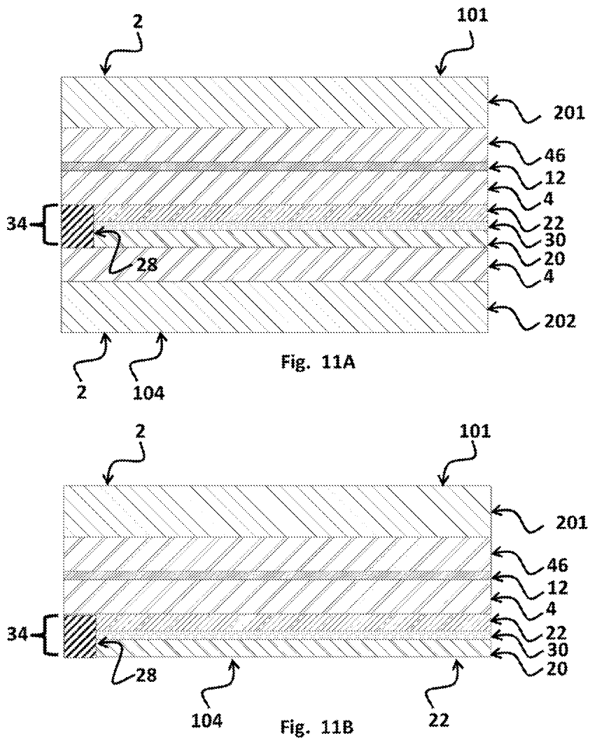

The organic materials of the variable light transmission cell 34 are also subject to degradation from long term exposure to heat. To reduce the thermal load on the vehicle and on the organics of the cell, an IR reflecting coating, IR absorbing interlayer or IR reflecting performance film may be added to the cross section of the laminate. Examples of IR coatings 18 are shown in FIGS. 7A, 7B, 9A, 9B, 10A and 10B. IR performance films 12 are shown in FIGS. 8A, 8B, 11A and 11B.

Variable light transmission cells 34 that are not sufficiently durable to survive the vacuum, pressure and temperatures required to produce an automotive laminate may still be laminated by means of an alternate process. A liquid optical clear adhesive, LOCA, may be used to bond the LC cell to the layers of the laminate. Examples of this are shown in FIGS. 6, 8A, 8B, 10A and 10B. When a LOCA is used, a perimeter edge seal 44 may be applied at the edge, or perimeter of the LOCA lamination area to contain the liquid. This is different from the cell edge seal used to seal the LC cell 34.

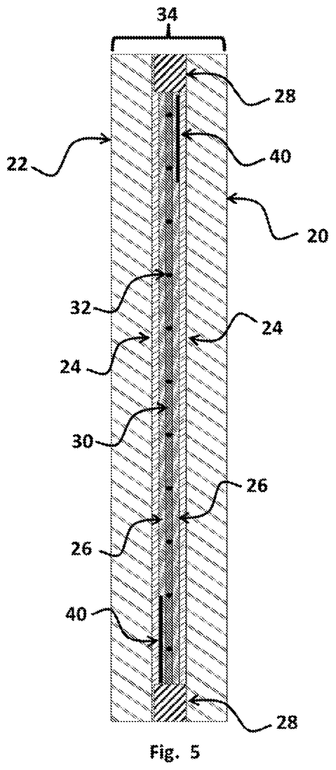

A typical cross section of the variable light transmission cell of the disclosure is illustrated in FIG. 5. The cell 34 comprises: a rigid substrate, 20 coated with a transparent conductive coating 24 in contact with a first electrical connector 40 and an alignment layer 26, a flexible substrate 22 coated with a transparent conductive coating 24 in contact with a second electrical connector 40 and an alignment layer 26, spacers 30 separating the two substrates, an cell emulsion 30 filling the void between two substrates and an edge seal 28 which serves to seal the edges of the two substrates and to contain the emulsion 30. The electrical connector, also known as bus bar, is selected from the group of thin metal strip, solid wire, stranded wire, braided wire, flexible printed circuit, conductive ink, silver frit or conductive tape. One or more electrical connectors could be included in the cell as needed.

The variable light transmission cell of the disclosure is not intended as a standalone glazing. Additional components are needed. In practice, the variable light transmission cell becomes an integral component of a laminated glazing. The cell is placed between the two transparent glazing layers and optically clear adhesive layers and then laminated. Depending upon the composition of the rigid substrate, the cell rigid substrate itself may be used to replace one of the transparent layers of the laminate. An optical clear adhesive, other than PVB may be used in place of the PVB. The optically clear adhesive is a transparent adhesive selected from the group of epoxy-based adhesive, acrylic-based adhesive, silicone-based adhesive, or liquid optically clear adhesive. If a liquid adhesive is used, a perimeter edge seal is needed to contain the adhesive during fill.

### EMBODIMENTS

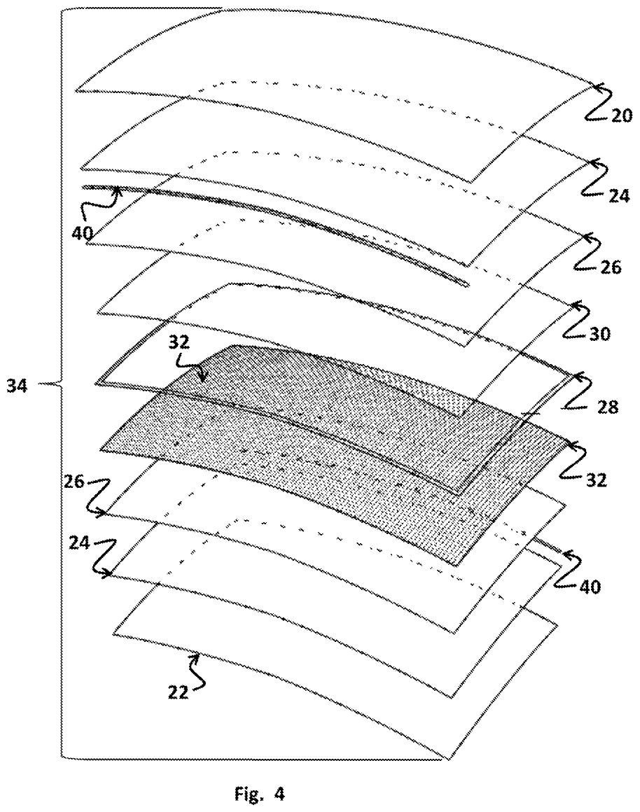

1. Embodiment one is an electrically controlled variable light transmission cell 34, as shown in FIG. 4. The cell comprises a rigid 1.1 mm soda lime clear glass rigid substrate 20 coated with ITO conductive coating 24 and has an alignment layer 26 made of polyimide applied over said coating. The glass rigid substrate 20 is curved having a high complexity curvature. The cell stack also comprises a flexible substrate 22 made of 0.1 mm transparent PET sheet, initially flat, also coated with ITO conductive coating 24 and also having a polyimide alignment layer 26 applied on top of the coating. The rigid and the flexible substrates are brought together, and transparent spacers 32 are placed in between the two substrates such that the coated surfaces of each substrate are facing each other, and a uniform gap is maintained in between. In doing that, the flexible substrate that is initially flat, conforms to the shape of the curved rigid substrate. An edge sealing 28, called cell edge sealing, is used on the perimeter of the gap between the two substrates so as to protect and hermetically seal a liquid crystal (LC) polymer emulsion inside the cell. Bus bars 40 are attached to the extremes of each substrate, serving as electrical connectors, and are in direct contact with the conductive coating 24 so as to provide electrical contact between a power control device and the cell. The assembled cell is filled with LC emulsion 30.

2. Embodiment two is similar to embodiment one, except that the rigid substrate 20 comprises 0.5 mm thick acrylic plastic with a carbon nano-tube coating 24 and an alignment layer 26. The rigid substrate 20 is vacuum formed over a mold. An 800 mm×1200 mm sheet of 120 micron thick, silver nano wire coated PET, with lithographically produced spacers having a height of 15 microns each and an alignment layer coating, is vacuum formed to match the contour of the formed ridge substrate 22 to form the flexible substrate 22. Bus bars 40 are applied to each substrate in electrical contact with the coating and extending outboard of the cell. The two substrates are joined with a cell edge seal 28 along the periphery of the cell. Openings are provided so as to fill the cell after lamination (not shown).

3. Embodiment three is similar to embodiments one or two, except that the rigid substrate is a 0.4 mm clear aluminosilicate glass.

4. Embodiment four is similar to embodiments one or two, except that the rigid substrate is a 2.5 mm clear borosilicate glass.

5. Embodiment five is similar to embodiments one or two, except that the rigid substrate is a 0.5 mm PC with high complexity curvature and the flexible substrate is a 0.1 mm PC layer.

6. Embodiment six is similar to embodiments one or two, except that the rigid substrate is made of a material selected to have a glass transition range of at least 10° C. higher than that of the flexible substrate.

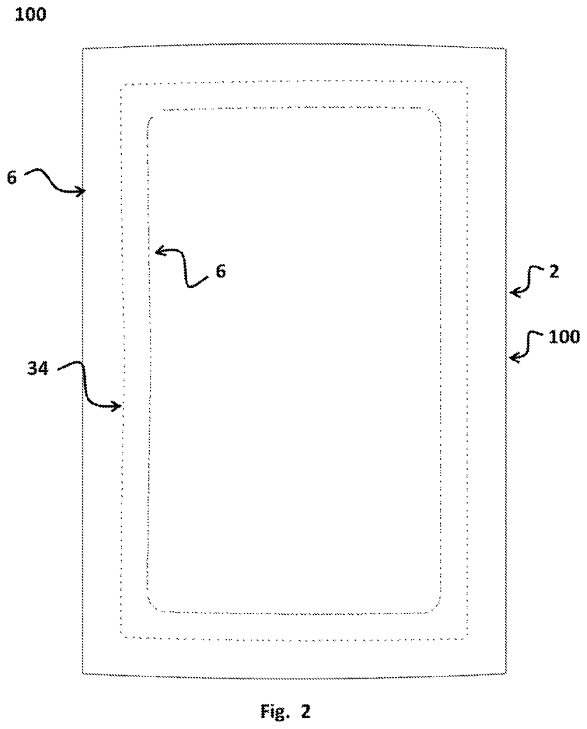

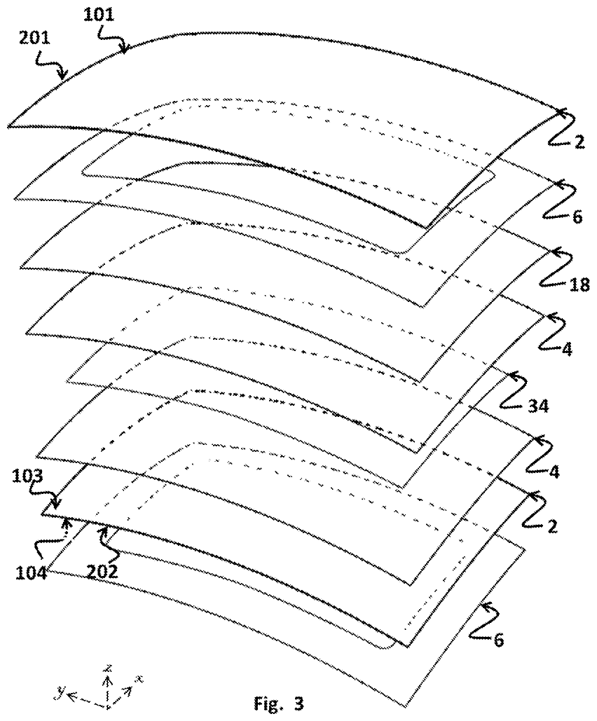

7. Embodiment seven is a large, laminated roof 100 with an electrically controlled variable light transmission cell 34, shown in FIGS. 2 and 3. The radius of curvature along the y axis is 2.5 meters and along the x axis the radius is 4 meters. This is a toroidal shape. The laminated roof 100 has an outer 201 and inner 202 glass layers comprising 2.3 mm solar green glass. A black obscuration 6 is printed on surface two 102 and surface four 104. Two sheets of PVB interlayer 4 are used to laminate the glass layers to the electrically controlled variable light transmission cell stack 34 of any of embodiments one to six. A 0.37 mm thick layer of gray PVB 4 with 20% light transmission is placed between the cell 34 and surface 102 of the outer glass layer 201 and a 0.76 mm clear layer of PVB 4 is placed between the cell 34 and surface 103 of the inner glass layer 202. The PVB layers provide UV protection to the electrically controlled variable light transmission cell stack. An IR coating is applied to surface 102 of the outer glass layer to provide for IR protection. FIG. 7A is a simple representation of this embodiment. The curved cell 34 is sandwiched between the PVB interlayers 4 of the laminate. The assembled laminate is vacuum channel preprocessed and then heat and pressure treated in an autoclave. During the preprocessing, vacuum forces the two substrates together. The flexible substrate 22 undergoes elastic deformation closing any gaps beyond that allowed by the spacers. During the autoclave cycle, the flexible substrate 22 is heated into its glass transition range, relieving the stress of deformation, and further allowing the flexible substrate 22 to take on the shape of the rigid substrate 20, compensating for any mismatch in contour between the two.

8. Embodiment eight is similar to embodiment six, except that the electrically controlled variable light transmission cell stack is laminated into the glazing using a liquid optically clear adhesive (LOCA) between the dark PVB layer in contact with surface 102 of the glazing. A glazing edge sealing is provided on the periphery of the glazing to protect and serve as a dam during the process of applying the LOCA. The adhesive is cured using a catalyst and after curing the cell stack stays permanently attached to the outer glass layer. The inner glass layer is attached to the cell stack using another layer of liquid optically clear adhesive that is cured by means of heating.

9. Embodiment nine is similar to embodiment seven or eight, except that the rigid substrate makes use of the inner glass layer 202 as shown in FIGS. 6 and 7B.

10. Embodiment ten is similar to any of the embodiments seven to nine, except that instead of an IR protection coating, an IR protection layer such as an IR-reflective PET film is sandwiched between two PVB interlayers. As a result, the glazing configuration can be illustrated such as in FIGS. 8A and 8B.

It must be understood that the present disclosure is not limited to the embodiments described and illustrated, as it will be obvious for an expert on the art, there are different variations and possible modifications that do not strive away from the disclosure's essence, which is only defined by the following claims.

1. A variable light transmission cell, comprising:
a rigid substrate with high complexity curvature coated with a transparent conductive coating, wherein said transparent conductive coating is in electrical contact with a first electrical connector;
a flexible substrate coated with a transparent conductive coating, wherein said conductive coating is in electrical contact with a second electrical connector;
at least one alignment layer deposited over the transparent conductive coating of either or each one of said rigid and flexible substrates;
spacers in between the rigid and the flexible substrates to maintain a uniform gap between the substrates;
an edge seal; and
an electrically controlled variable light transmission material filling the gap between the rigid and the flexible substrates.

2. The variable light transmission cell of claim 1, wherein the first and second electrical connectors serve to conduct electrical current between said cell and an electrical current source.

3. The variable light transmission cell of claim 1, wherein said edge seal serves to bond and seal the rigid and the flexible substrates positioned such that the transparent conductive coating of each one of said substrates are facing each other.

4. The variable light transmission cell of claim 1, wherein the flexible substrate is formed to the rigid substrate taking the same high complexity curvature.

5. (canceled)

6. The variable light transmission cell of claim 1, wherein the rigid substrate and the flexible substrate comprise plastic layers selected from the group of: PMMA, PC, PET, PETG, PETA, PEN, PI, TAC, COP, LDPE, LLDPE, HDPE, PP or glass layers selected from the group of: soda lime, aluminosilicate, borosilicate, among other types of transparent glass.

7. The variable light transmission cell of claim 1, wherein the rigid substrate has a different Elastic Modulus than the flexible substrate.

8. The variable light transmission cell of claim 1, wherein the axial stiffness of the rigid substrate is at least 50% greater than the axial stiffness of the flexible substrate.

9. The variable light transmission cell of claim 1, wherein the rigid substrate is thicker than the flexible substrate.

10. The variable light transmission cell of claim 1, wherein the transparent conductive coating is selected from the group comprising: metallic/dielectric, ITO, ITO over a metallic/dielectric, carbon nanotubes, silver nanowires, ITO plus carbon nanotubes, ITO plus silver nanowires, or polymeric conductive coating.

11. The variable light transmission cell of claim 1, wherein the first and second electrical connectors are selected from the group of: thin metal strip, solid wire, stranded wire, braided wire, flexible printed circuit, conductive ink, silver frit, and conductive tape.

12. A glazing with high complexity curvature having the variable light transmission cell of claim 1, wherein the glazing comprises:
at least two glass layers with high complexity curvature with each having first and second major surfaces;
at least one Ultraviolet blocking layer; and
at least one optically clear adhesive layer serving to bond the variable light transmission cell either between the at least two glass layers or, in the case where one of said at least two glass layers serves as the rigid substrate of the variable light transmission cell, said at least one optically clear adhesive bonds the cell to the other of said two glass layers.

13. The glazing with high complexity curvature of claim 12, further comprising at least one Infrared reflecting layer.

14. The glazing with high complexity curvature of claim 12, wherein said at least one Infrared reflecting layer comprises an IR reflective film layer or an IR reflecting coating applied to at least one glass layer of the glazing.

15. The glazing with high complexity curvature of claim 12, wherein said at least one Ultraviolet protection layer provides a light transmission of less than 5% in the wavelength range of 280 nm to 410 nm.

16. The glazing with high complexity curvature of claim 12, wherein said at least one Ultraviolet protection layer is substantially comprised of polyvinyl butyral.

17. The glazing with high complexity curvature of claim 12, wherein said optically clear adhesive layer is a transparent adhesive selected from the group of: epoxy-based adhesive, acrylic-based adhesive, silicone-based adhesive, or liquid optically clear adhesive.

18. (canceled)

19. (canceled)

20. A method of manufacture of variable light transmission cell, comprising the steps of:
providing a rigid substrate;
applying a transparent conductive coating to said rigid substrate;
applying a first electrical connector to said rigid substrate wherein said first electrical connector is in electrical contact with said transparent conductive coating;
forming said rigid substrate to the desired shape such as to form a high complexity curvature;
providing a flexible substrate;
applying an alignment layer over the transparent conductive coating of said rigid, or flexible, or both substrates prior or after forming the rigid substrate;
applying a transparent conductive coating to said flexible substrate;
applying a second electrical connector to said flexible substrate wherein said second electrical connector is in electrical contact with said flexible transparent conductive coating;
applying spacers to said rigid substrate or applying spacers to said flexible substrate or applying spacers to the gap between the two substrates such that the gap formed is uniform;
bringing the two substrates together with the transparent conductive coating on the flexible and rigid substrates facing each other such that the flexible substrate is formed to the rigid substrate taking the same high complexity curvature and forming an assembly;
sealing and bonding the edges of the assembly with an edge seal; and
filling the gap of said sealed assembly with an electrically controllable variable light transmission material.

21. (canceled)

22. The method of manufacture of claim 20, wherein the rigid substrate is formed prior to the application of the transparent conductive coating.

23. (canceled)

24. The method of manufacture of claim 20, wherein spacers are applied to either of said substrates prior to said substrate being formed.

25. (canceled)

26. The method of manufacture of claim 20, wherein the curved rigid substrate is used as a mold to form the flexible substrate.
